(19) United States
(12) Patent Application Publication
(10) Pub. No.: US 2015/0209728 A1
(43) Pub. Date: Jul. 30, 2015

(54) EQUIPMENT AND METHOD FOR CONTROLLING EMISSIONS OF MONO-NITROGEN OXIDES (NOX) AND CARBON MONOXIDE (CO) FROM FLUID CATALYTIC CRACKING (FCC) UNITS

(71) Applicant: UOP LLC, Des Plaines, IL (US)

(72) Inventor: Patrick D. Walker, Park Ridge, IL (US)

(73) Assignee: UOP LLC, Des Plaines, IL (US)

(21) Appl. No.: 14/168,880

(22) Filed: Jan. 30, 2014

(51) Int. Cl. B01D 53/86

(52) U.S. Cl. CPC B01D 53/8696; B01D 53/8653

(57) ABSTRACT

A process for controlling emissions from a regenerator vessel that is part of a fluid catalytic cracking unit including a reactor, where the process includes setting a predetermined temperature value in a control unit, wherein the predetermined temperature is the desired temperature within the regenerator vessel. The process also preferably includes controlling the actual temperature within the regenerator vessel by using the predetermined temperature value set in the control unit to appropriately increase or decrease the amount of catalyst being recycled within the reactor.

This invention relates to a process for controlling emissions from a fluid catalytic cracking unit, and more particularly to a process for automatically controlling the emissions of carbon monoxide and/or mono-nitrogen oxides from a regenerator of a fluid catalytic cracking unit.

### BACKGROUND OF THE INVENTION

Emissions of both carbon monoxide (CO) and mono-nitrogen oxides (which are commonly referred to as NOₓ, and which include nitric oxide (NO) and nitrogen dioxide (NO₂)), from the stacks of fluid catalytic cracking (FCC) units are generally regulated by local government authorities. Typically these emissions are based on a seven day rolling average of maximum allowable emissions and a calendar year maximum allowable emissions. Exceeding the allowable limits for either of these components generally results in reporting requirements and/or potential penalties, as well as other undesirable consequences. In order to ensure that the limits are not exceeded, many refiners target the operation of their FCC units with substantial margins that are well below the limits in order to accommodate upsets, such as feedstock changes, wherein the limit could possibly be exceeded. Margin is expensive in terms of catalyst additives and utility consumption, and perhaps capacity as well. Thus, the present inventor has determined that there is a need to flatten out the emissions response in order to accommodate upsets whereby the margin can be minimized and the refiner can be more confident of their ability to avoid exceeding the required limits.

Simultaneous control of both CO emissions and NOₓ emissions from an FCC unit is a difficult challenge. For example, CO can be reduced by increasing the excess oxygen in the flue gas, but this comes with the penalty of higher NOₓ emissions and higher utility costs (for the main air blower driver). CO emissions can also be controlled by using a CO promoter, but this too increases NOₓ emissions, and CO promoter is relatively expensive. Increasing the regenerator temperature reduces both CO emissions and NOₓ emissions. However, in a conventional FCC unit, the regenerator temperature is a dependant variable which will float as the unit operating conditions are optimized for maximum gross margin. The resulting optimum regenerator temperature for maximum gross margin is frequently below the optimum regenerator temperature required for minimizing emissions to the mandated levels.

### BRIEF SUMMARY OF THE INVENTION

Adding advanced catalyst recycling techniques to an FCC unit allows the operator to independently control the regenerator temperature required for minimizing emissions. However, there is no established effective control strategy for controlling the amount of recycled catalyst being provided to the lower portion of the reactor, aside from the operator manually regulating the flow of recycled catalyst, such as by setting the opening of a slide valve. The present invention provides a control scheme for automatically controlling the flow of recycled catalyst by using a control unit to control a control valve, such as a slide valve within a recycled catalyst conduit, based on the temperature of the regenerator. In certain embodiments of the present invention, the temperature of the regenerator is taken within a lower chamber, also referred to as the combustor.

Briefly, certain embodiments of the present invention relate to the use of recycled catalyst in the reactor of an FCC unit, where the invention provides a unique control scheme whereby a temperature indicating controller is provided in a portion of the regenerator, such as in the combustor, which controls a control valve, such as a slide valve, within a recycled catalyst conduit of the reactor. With such a control scheme, the regenerator temperature can be maintained at the optimum temperature, even during upsets such as feedstock changes. With constant regenerator temperature, the excess oxygen in the flue gas of the regenerator can then be reduced by reducing the main air, thereby saving utility costs and reducing NOₓ emissions, even as CO emissions trend up. The ideal combination of regenerator temperature and excess oxygen can be established by experimentation with the particular FCC unit.

In particular, certain embodiments of the present invention relate to a process for controlling emissions from a regenerator vessel that is part of a fluid catalytic cracking unit including a reactor, where the process includes setting a predetermined temperature value in a control unit, wherein the predetermined temperature is the desired temperature within the regenerator vessel. The process also preferably includes controlling the actual temperature within the regenerator vessel by using the predetermined temperature value set in the control unit to appropriately increase or decrease the amount of catalyst being recycled within the reactor.

In other embodiments, the invention relates to a process for controlling emissions of mono-nitrogen oxides and carbon monoxide from a fluid catalytic cracking unit that includes a regenerator vessel and a reactor vessel. Preferably, the process includes storing a predetermined temperature value in a control unit; determining the actual temperature within a portion of the regenerator vessel; and supplying the determined actual temperature to the control unit. Such a process also preferably includes using the control unit to control the operation of a control valve associated with the reactor vessel based on a comparison of the determined actual temperature and the stored predetermined temperature.

In other embodiments, the present invention provides a fluid catalytic cracking unit that includes a reactor including a separator vessel; a riser located within the separator vessel; a blending vessel in communication with a lower portion of the riser; and a recycled catalyst conduit for passing catalyst from the separator vessel to the blending vessel. Preferably, the recycled catalyst conduit includes a control valve for regulating the flow of catalyst between the separator vessel and the blending vessel. Preferred embodiments also include a regenerator for regenerating catalyst; a carbonized catalyst conduit for passing carbonized catalyst from the reactor to the regenerator; and a controller for controlling the control valve to increase or decrease the flow of catalyst to the blending vessel based on the temperature of the regenerator.

### BRIEF DESCRIPTION OF THE DRAWING

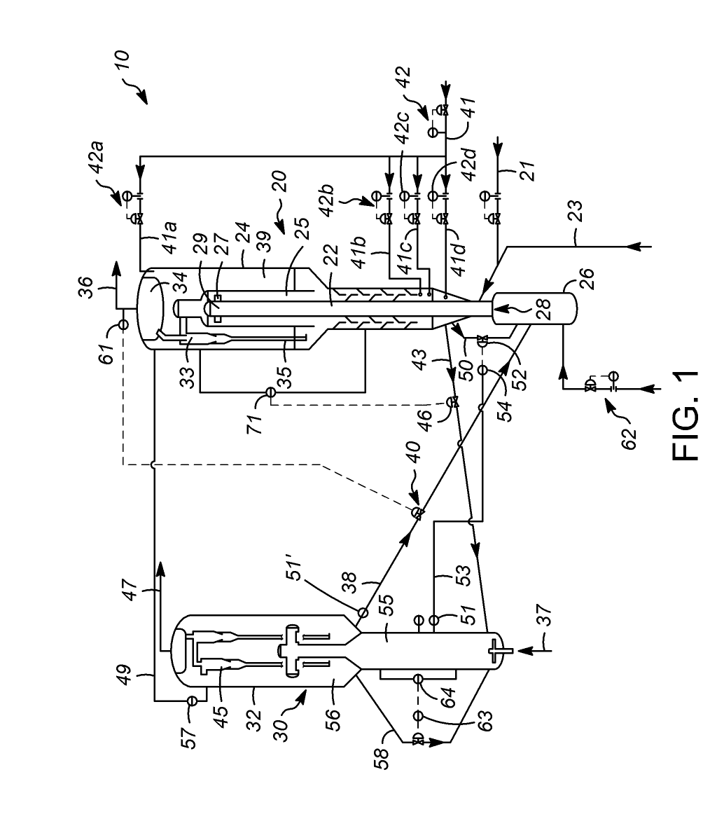

A preferred embodiment of the present invention is described herein with reference to the drawing wherein FIG. 1 is a schematic of an exemplary fluid catalytic cracking unit for exampling the control scheme of the present invention.

### DETAILED DESCRIPTION OF THE INVENTION

FIG. 1 shows a schematic arrangement of an example of a fluid catalytic cracking (FCC) unit 10 that could be used with the present invention. Of course other embodiments are also contemplated, and thus the description of the present invention in the context of the specific process arrangement shown is not meant to limit it to the details disclosed therein. The FCC unit 10 shown in FIG. 1 is divided into a reaction zone 20 that includes an elongate riser 22 and a separator vessel 24; and a regeneration zone 30 that includes a regenerator 32. The arrangement circulates catalyst and contacts feed in the manner hereinafter described.

The catalyst that enters the riser 22 can include any of the well-known catalysts that are used in the art of fluidized catalytic cracking. These compositions include amorphous-clay type catalysts or high activity, crystalline alumina silica or zeolite containing catalysts.

FCC feedstocks, suitable for processing by the method of this invention, include conventional FCC feeds, as well as higher boiling or residual feeds. One example of a feed is a vacuum gas oil, which is preferably a hydrocarbon material having a boiling range of from about 650° F. to about 1025° F. (about 343° C. to about 552° C.) and which is prepared by vacuum fractionation of atmospheric residue.

Riser 22 is just one type of conversion vessel that can be used in conjunction with this invention. The riser type conversion vessel comprises a conduit for the pneumatic conveyance of the blended catalyst mixture and the feed stream. The base of the riser 22 in this embodiment includes a blending vessel 26.

Feed is introduced into the riser 22 by a feed pipe 23 located somewhere between an inlet portion 28 and substantially upstream from an outlet portion 29. Atomizing steam can be provided to feed pipe 23 via line 21, which includes appropriate controls, in order to help disperse the feed into the catalyst within the riser 22. The connection of the feed pipe 23 to the riser 22 is preferably located in a lower portion of the riser 22. Before contacting the catalyst, the feed will ordinarily have a temperature in a range of from about 300° F. to about 600° F. (about 149° C. to about 316° C.). Additional amounts of feed may be added downstream of the initial feed point, if desired.

A regenerated catalyst conduit 38 passes regenerated catalyst from the regenerator 32 into the blending vessel 24 at a circulation rate regulated by a control valve 40, such as a slide valve, as explained in more detail below. In embodiments without a blending vessel, conduit 38 directs the regenerated catalyst into the lower portion of the riser 22.

A recycled catalyst conduit 50 passes catalyst from the separator vessel 24 at a circulation rate regulated by a control valve 52, such as a slide valve, into the blending vessel 26. As described more fully below, the operation of the control valve 52 is controlled by a control unit 54, such as an electrohydraulic actuator, or other device that includes a computer processor with a storage device or any other type of memory.

Fluidizing gas passed into blending vessel 26 from a conduit 60 (controlled by a controller and control valve 62) contacts the catalyst and maintains the catalyst in a fluidized state to mix the recycled catalyst and regenerated catalyst.

The regenerated catalyst will have a substantially higher temperature than the recycled catalyst. Regenerated catalyst from the regenerated catalyst conduit 38 will usually have a temperature in a range from about 1100° F. to about 1400° F. (about 593° C. to about 760° C.) and, more typically, in a range of from about 1200° F. to about 1400° F. (about 649° C. to about 760° C.). The temperature of the recycled catalyst will usually be in a range of from about 900° F. to about 1150° F. (about 482° C. to about 621° C.). The relative proportions of the recycled catalyst and regenerated catalyst will determine the temperature of the blended catalyst mixture that contacts the feed. The blended catalyst mixture will usually range from about 1000° F. to about 1400° F. (about 538° C. to about 760° C.) and, more preferably is in a range of from about 1050° F. to about 1250° F. (about 566° C. to about 677° C.). Preferably, the ratio of recycled catalyst to regenerated catalyst entering the blending zone will be in a broad range of from 0.1 to 5 and more preferably in a range of from 0.5 to 1.0. Once the blended catalyst mixture contacts the feed, the blended catalyst mixture cracks the feed into smaller molecules.

The separator vessel 24 preferably includes a stripping vessel 25. The blended catalyst mixture and reacted feed vapors are discharged from the end of riser 22 through an outlet 27 into the stripping vessel 25 of the separator vessel 24.

In this embodiment, a swirl arm arrangement is provided at the outlet 27 at the end of the riser 22 to impart a tangential velocity to the exiting catalyst and converted feed mixture to separate a product vapor stream from a collection of catalyst particles covered with substantial quantities of coke and generally referred to as “spent catalyst,” or more preferably referred to as “carbonized catalyst,” since there may still be a significant amount of activity in such catalyst.

The product vapor stream at the top of the stripping vessel 25 is passed to one or more cyclone separators 33 in a primary chamber 39 of the separator vessel 24. The one or more cyclone separator(s) 33 further remove catalyst particles from the product vapor stream to reduce particle concentrations to very low levels. Product vapors comprising cracked hydrocarbons and some catalyst exit the top of separator vessel 24 through conduit 36 via a plenum chamber 34. Catalyst separated by cyclone separator(s) 33 returns to the separator vessel 24 through dipleg conduits 35 into a dense catalyst bed (not shown).

Catalyst drops through the stripping vessel 25 that removes adsorbed hydrocarbons from the surface of the catalyst by counter-current contact with steam. Steam enters the stripping vessel 25 through at least one line 41, which in this embodiment is further divided into four lines 41a, 41b, 41c and 41d, each with an associated control valve 42a, 42b, 42c and 42d, respectively, as well as main control valve 42 associated with main line 41.

Spent (carbonized) catalyst stripped of hydrocarbon vapor leaves the bottom of the stripping vessel 25 through a spent (or carbonized) catalyst conduit 43 at a rate regulated by a control valve 46, such as a slide valve, as explained more fully below.

Spent (carbonized) catalyst to be recycled to the base of the riser 22 may be withdrawn from the separator vessel 24, or even riser 22, after the spent (carbonized) catalyst has undergone a sufficient reduction in temperature. Spent (carbonized) catalyst can be withdrawn downstream of the riser 22 and/or from the stripping vessel 25. The FIG. 1 embodiment depicts the withdrawal of spent (carbonized) catalyst from a lower portion of the stripping vessel 25 via the recycled catalyst conduit 50, which transfers one portion of the spent (carbonized) catalyst exiting the separator vessel 24 back to the blending vessel 26 as recycled catalyst. If a blending vessel is not provided, the spent (carbonized) catalyst from conduit 50 is directed to a lower portion of riser 22. The spent (carbonized) catalyst conduit 43 transfers another portion of the spent (carbonized) catalyst to the regenerator 32 for the removal of coke in the regeneration zone 30.

On the regeneration side of the process, spent (carbonized) catalyst transferred to the regenerator 32 via spent (carbonized) catalyst conduit 43 undergoes the typical combustion of coke from the surface of the catalyst particles by contact with an oxygen-containing gas. The oxygen-containing gas of a stream 37 enters the bottom of the regenerator 32 via an inlet 38, and passes through a dense fluidizing bed of catalyst (not shown). Flue gas consisting primarily of CO or CO₂ passes upward from the dense bed into a dilute phase of the regenerator 32.

A separator, such as cyclones 44 and 45, removes entrained catalyst particles from the rising flue gas before the flue gas exits the vessel through an outlet stream 47. Outlet stream 47 is the stream that includes the carbon monoxide (CO) and mono-nitrogen oxides (which are commonly referred to as NOx, and which include nitric oxide (NO) and nitrogen dioxide (NO₂)) intended to be controlled by the present invention.

Combustion of coke from the catalyst particles raises the temperatures of the catalyst to those previously described. The regenerated catalyst is transferred by the regenerated catalyst conduit 38 to the blending vessel 26 at the base of the riser 22 in the reaction zone 20. The embodiment of the regenerator 32 shown in FIG. 1 also preferably includes a conduit 58 for transferring catalyst between the upper chamber 56 and the lower chamber 55, as regulated by a control valve 59, which is controlled by electrohydraulic actuator 63 and controller 64, such as a density controller. Components 63 and 64 are used to adjust a valve, such as a slide valve 65, in conduit 58 to achieve the desired density in the lower chamber 55 of the regenerator 32.

The circulation rate of spent (carbonized) catalyst from the separator vessel 24 to the regenerator 32 through the spent (carbonized) catalyst conduit 43 is regulated by the control valve 46, and the circulation rate of regenerated catalyst from the regenerator 32 to the blinding vessel 26 at the base of the riser 22 is controlled by the control valve 40.

One of the important features of the present invention is that the circulation rate of spent (carbonized) catalyst from the stripping vessel 25 of the separator vessel 24 through the recycled catalyst conduit 50 is regulated by the control valve 52 (such as a slide valve), which is associated with the control unit 54. As can be seen in FIG. 1, the control unit 54 is connected, via connection 53, to a temperature indicator controller (TIC) 51 that monitors the temperature within a lower chamber 55 of the regenerator 32. The connection 53 may be any known connection means for providing electrical signals between the control unit 54 and the controller 51, such as a wired or wireless connection. As an alternative to positioning the temperature indicator controller (TIC) 51 to be associated with the lower chamber 55 of the regenerator, it may be associated with the upper chamber 56 of the regenerator, such as represented in FIG. 1 by temperature indicator controller (TIC) 51′, which is shown along the regenerated catalyst conduit 38.

Preferably, the operator will assign the desired regenerator temperature to the temperature indicator controller 51, and the control valve 52 will be controlled by the control unit 54 to automatically open or close the valve 52 (preferably a slide valve) to maintain the desired temperature in the lower chamber 55 of the regenerator 32. For example, in certain embodiments, the predetermined temperature is a single value between about 1300° F. to about 1350° F. (about 704° C. to about 732° C.). Such predetermined temperature valves can be determined by experimentation.

More specifically, under such a configuration, a predetermined desired temperature for the lower chamber 55 of the regenerator 32 is input into the control unit 54 by the operator, and during operation, the temperature indicator controller 51 determines the actual temperature of the lower chamber 55 of the regenerator 32. Next, an electrical signal representing the actual temperature of the lower chamber 55 of the regenerator 32 is supplied from the temperature indicator controller 51 to the control unit 54 (via connection 53), whereby the control unit 54 compares the actual temperature with the predetermined desired temperature. The control unit 54 then uses such comparison for controlling the operation of the control valve 52 to regulate the flow of recycled catalyst through recycled catalyst conduit 50 to the blending vessel 26 of the reaction zone 20. For example, if the control valve 52 is a slide valve, and the comparison reveals that the actual temperature is lower than the predetermined desired temperature, the slide valve 52 is opened wider to allow more recycled catalyst to pass through conduit 50 into the blending vessel 26. On the other hand, if the comparison reveals that the actual temperature is higher than the predetermined desired temperature, the slide valve 52 is closed more, allowing less recycled catalyst to pass through conduit 50 into the blending vessel 26. This is the case because adjusting the quantity of recycled catalyst in the reaction zone 20 affects the temperature of the regenerator 32. In particular, regenerator temperature is a strong function of Δ coke, which is defined as the difference in coke content between the regenerated catalyst and the spent (carbonized) catalyst. As the catalyst recycling process is increased by providing more recycled catalyst in the blending vessel 26, the Δ coke increases due to recycling catalyst particles completing additional passes through the riser 22 prior to being passed to the regeneration zone 30. Such an increase in Δ coke from the catalyst recycling process in the reaction zone 20 increases the temperature of the regenerator 32 in the regeneration zone 30.

Thus, by controlling the temperature of the lower chamber 55 of the regenerator to a predetermined value, the emissions of both CO and NOₓ gases through the stream 47 can be reduced to satisfy the allowable emission requirements of the local government entities. On the other hand, without the control system of the present invention, the temperature of the lower chamber 55 of the regenerator 32 will move up or down, sometimes dramatically (and consequently move away from optimum values) based on various variables, such as feed quality, reactor temperature, feed temperature, catalyst addition rate, ambient air temperature, the feedrate, etc.

Turning again to FIG. 1, other control features of the exemplary embodiment of FCC unit 10 will be described. The spent (carbonized) catalyst control valve 46, which could be a slide valve, is also preferably automatically controlled. Such automatic control could include a level indicating controller (LIC) 71 that receives signals of the levels of the catalyst in the separator vessel 24 and in the stripping vessel 25. The LIC 71 signals to a low signal selector (LSS) associated with control valve 46 a setting for the slide valve 46 relative to fully open to bring the respective levels in the separator vessel 24 and in the stripping vessel 25 to the desired preset levels. The regenerated catalyst control valve 40, which may also be a slide valve, is also preferably automatically controlled by any desired method, such as with a temperature indicating controller (TIC) 61 that receives a temperature signal of the effluent gas from the separator vessel 24 in conduit 36, and signals a setting to the associated slide valve 40 to effect the preset temperature desired in the separator vessel 24.

The regenerated catalyst conduit 38, the spent (carbonized) catalyst conduit 43 and the recycled catalyst conduit 50 preferably also include instrumentation to control and monitor the flows, such as those components described in U.S. Pat. No. 7,041,259, which is hereby incorporated by reference in its entirety.

As explained above, the present invention relates to a control scheme for automatically controlling the flow of recycled catalyst through recycled catalyst conduit 50. Without such a control scheme, a recycled catalyst slide valve, or other control valve, would be set and operated manually, whereby the operator opens or closes the valve position based on the information he has available to him from various indicators, and his judgment, experience and objectives.

As discussed in detail above, the control unit 54, in conjunction with temperature indicating controller 51, control valve 52 and connection 53, represent the new control scheme in which the operator assigns the desired regenerator temperature to the temperature controller 51 (similar to a thermostat), and the recycled catalyst valve 52 opens/closes automatically, thereby allowing the desired recycled catalyst flow rate through conduit 50, to maintain the desired temperature in the regenerator. Thus, embodiments of the present invention allow for CO and NOₓ emissions to be simultaneously minimized (or more accurately, optimized, based on allowable annual emissions from local air quality board) by selecting the proper temperature, which can be determined by simple testing at various temperatures. Note that without this control scheme, the regenerator temperature will move up or down, sometimes dramatically (and consequently move off optimum) based on various variables, such as feed quality, reactor temperature, feed temperature, catalyst addition rate, ambient air temperature, feedrate, etc.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A process for controlling emissions from a regenerator vessel that is part of a fluid catalytic cracking unit including a reactor, the process comprising:
setting a predetermined temperature value in a control unit, wherein the predetermined temperature value is the desired temperature within the regenerator vessel; and
controlling the actual temperature within the regenerator vessel by using the predetermined temperature value set in the control unit to appropriately increase or decrease the amount of catalyst being recycled within the reactor.

2. The process according to claim 1, wherein the controlling includes controlling a control valve positioned within a recycled catalyst conduit for passing catalyst between a separator vessel of the reactor and a riser of the reactor to increase or decrease the flow of catalyst though the recycled catalyst conduit.

3. The process according to claim 1, wherein the controlling includes regulating an opening defined by a slide valve, wherein the slide valve is positioned within a recycled catalyst conduit for passing catalyst between a separator vessel of the reactor and a riser of the reactor.

4. The process according to claim 1, wherein the predetermined temperature value is based, at least in part, on the level of carbon monoxide emissions from an outlet stream of the regenerator vessel.

5. The process according to claim 1, wherein the predetermined temperature value is based, at least in part, on the level of emissions of mono-nitrogen oxides from an outlet stream of the regenerator vessel.

6. The process according to claim 1, wherein the predetermined temperature value is based on the level of emissions of carbon monoxide and mono-nitrogen oxides from an outlet stream of the regenerator vessel.

7. The process according to claim 1, wherein the predetermined temperature value is selected to maintain the emissions of carbon monoxide and mono-nitrogen oxides from an outlet stream of the regenerator vessel at constant levels.

8. The process according to claim 1, wherein the controlling maintains the actual temperature within the regenerator at approximately the predetermined temperature value, regardless of feedstock conditions.

9. The process according to claim 1, wherein the regenerator vessel includes an upper chamber and a lower chamber, and further wherein the predetermined temperature value is the desired temperature within the lower chamber of the regenerator vessel and the actual temperature is a temperature measured at a location within the lower chamber of the regenerator vessel.

10. The process according to claim 1, wherein the regenerator vessel includes an upper chamber and a lower chamber, and further wherein the predetermined temperature value is the desired temperature within the upper chamber of the regenerator vessel and the actual temperature is a temperature measured at a location within the upper chamber of the regenerator vessel.

11. A process for controlling emissions of mono-nitrogen oxides and carbon monoxide from a fluid catalytic cracking unit that includes a regenerator vessel and a reactor vessel, the process comprising:
storing a predetermined temperature value in a control unit;
determining the actual temperature within a portion of the regenerator vessel;
supplying the determined actual temperature to the control unit; and
using the control unit to control the operation of a control valve associated with the reactor vessel based on a comparison of the determined actual temperature and the stored predetermined temperature value.

12. The process according to claim 11, wherein the control valve is positioned within a recycle catalyst conduit for passing catalyst from a separator vessel of the reactor and a blending vessel of the reactor, and thereby the control valve controls the flow catalyst from the separator vessel to the blending vessel.

13. The process according to claim 12, wherein the control valve is a slide valve, and the control unit controls the opening defined by the slide valve by increasing or decreasing the size of the opening based on the comparison of the determined actual temperature and the stored predetermined temperature value.

14. The process according to claim 11, wherein the predetermined temperature value is selected to maintain the emissions of carbon monoxide and mono-nitrogen oxides from an outlet stream of the regenerator vessel at constant levels.

15. The process according to claim 11, wherein the control unit comprises a computer processor.

16. A fluid catalytic cracking unit comprising:
a reactor including a separator vessel;
a riser located within the separator vessel;
a blending vessel in communication with a lower portion of the riser;
a recycled catalyst conduit for passing catalyst from the separator vessel to the blending vessel, wherein the recycled catalyst conduit includes a control valve for regulating the flow of catalyst between the separator vessel and the blending vessel;
a regenerator for regenerating catalyst;
a carbonized catalyst conduit for passing carbonized catalyst from the reactor to the regenerator; and
a controller for controlling the control valve to increase or decrease the flow of catalyst to the blending vessel based on the temperature of the regenerator.

17. The fluid catalytic cracking unit according to claim 16, wherein the controller comprises a computer processor and a storage device, and further wherein the storage device includes a predetermined temperature value for the regenerator stored therein.

18. The fluid catalytic cracking unit according to claim 16, wherein the regenerator includes an upper chamber and a lower chamber, and further wherein the lower chamber includes a temperature indicating controller for determining the actual temperature within the lower chamber and for communicating the actual temperature to the controller for controlling the control valve.

19. The fluid catalytic cracking unit according to claim 16, further comprising a recycled catalyst conduit for passing catalyst between a separator vessel of the reactor and a riser of the reactor, and wherein the control valve is a slide valve positioned within the recycled catalyst conduit.

20. The fluid catalytic cracking unit according to claim 19, further comprising a regenerated catalyst conduit for passing regenerated catalyst from an upper chamber of the regenerator to a blending vessel of the reactor.
